(19) United States
(12) Patent Application Publication
(10) Pub. No.: US 2008/0195239 A1
(43) Pub. Date: Aug. 14, 2008

(54) COLLABORATIVE PLAYLIST SYSTEM AND METHOD

(76) Inventors: Ben Aaron Rotholtz, Yarrow Point, WA (US); Leo Parker Dirac, Seattle, WA (US)

Correspondence Address: HOLLAND & KNIGHT LLP, 10 ST. JAMES AVENUE, BOSTON, MA, 02116, US

(21) Appl. No.: 11/672,741

(22) Filed: Feb. 8, 2007

(51) Int. Cl. G06F 17/00

(52) U.S. Cl. 700/94; 707/1

(57) ABSTRACT

A method and computer program product for monitoring a listening history of a first user. A listening history of at least a second user is monitored. At least a portion of the listening history of the first user is combined with at least a portion of the listening history of at least the second user to generate a hybrid listening history. The hybrid listening history is processed to generate a collaborative playlist.

### TECHNICAL FIELD

This disclosure relates to playlists and, more particularly, to collaborative playlists based on the listening history of multiple users.

### BACKGROUND

Media distribution systems (e.g., the Rhapsody™ service offered by RealNetworks, Inc of Seattle, Wash.) distribute media content to client electronic devices (e.g., MP3 players) from e.g., data servers. A media distribution system may distribute media content by allowing a user to download media data files and/or receive and process media data streams (collectively referred to as tracks).

Media distribution systems may allow a user to define playlists, such that individual media tracks are provided to the user in a fashion similar to that of a traditional radio station.

### SUMMARY OF DISCLOSURE

In a first implementation, a method includes monitoring a listening history of a first user. A listening history of at least a second user is monitored. At least a portion of the listening history of the first user is combined with at least a portion of the listening history of at least the second user to generate a hybrid listening history. The hybrid listening history is processed to generate a collaborative playlist.

One or more of the following features may be included. Access to the collaborative playlist may be provided to third parties. Processing the hybrid listening history may include deleting one or more items from the hybrid listening history. Processing the hybrid listening history may include adding one or more items to the hybrid listening history. Processing the hybrid listening history may include applying one or more rules to the hybrid listening history.

The rules may be chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule. The first and/or at least the second user may be allowed to select one or more rules for applying to the hybrid listening history. The collaborative playlist may be maintained on a client electronic device and/or a server computer.

Monitoring a listening history of a first user may include one or more of: monitoring one or more playlists created by the first user; monitoring one or more playlists rendered by the first user; and monitoring one or more tracks rendered by the first user. Monitoring a listening history of at least a second user may include one or more of: monitoring one or more playlists created by the at least a second user; monitoring one or more playlists rendered by the at least a second user; and monitoring one or more tracks rendered by the at least a second user. The first user and the at least a second user may be the same user.

In another implementation, a computer program product resides on a computer readable medium that has a plurality of instructions stored on it. When executed by a processor, the instructions cause the processor to perform operations including monitoring a listening history of a first user. A listening history of at least a second user is monitored. At least a portion of the listening history of the first user is combined with at least a portion of the listening history of at least the second user to generate a hybrid listening history. The hybrid listening history is processed to generate a collaborative playlist.

One or more of the following features may be included. Access to the collaborative playlist may be provided to third parties. Processing the hybrid listening history may include deleting one or more items from the hybrid listening history. Processing the hybrid listening history may include adding one or more items to the hybrid listening history. Processing the hybrid listening history may include applying one or more rules to the hybrid listening history.

The rules may be chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule. The first and/or at least the second user may be allowed to select one or more rules for applying to the hybrid listening history. The collaborative playlist may be maintained on a client electronic device and/or a server computer.

Monitoring a listening history of a first user may include one or more of: monitoring one or more playlists created by the first user; monitoring one or more playlists rendered by the first user; and monitoring one or more tracks rendered by the first user. Monitoring a listening history of at least a second user may include one or more of: monitoring one or more playlists created by the at least a second user; monitoring one or more playlists rendered by the at least a second user; and monitoring one or more tracks rendered by the at least a second user. The first user and the at least a second user may be the same user.

In another implementation, a method includes monitoring a listening history of a first user. A listening history of at least a second user is monitored. At least a portion of the listening history of the first user is combined with at least a portion of the listening history of at least the second user to generate a hybrid listening history. One or more rules are applied to the hybrid listening history to generate a collaborative playlist. The rules are chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule.

One or more of the following features may be included. The first and/or at least the second user may be allowed to select one or more rules for applying to the hybrid listening history. The collaborative playlist may be maintained on a client electronic device and/or a server computer.

Monitoring a listening history of a first user may include one or more of: monitoring one or more playlists created by the first user; monitoring one or more playlists rendered by the first user; and monitoring one or more tracks rendered by the first user. Monitoring a listening history of at least a second user may include one or more of: monitoring one or more playlists created by the at least a second user; monitoring one or more playlists rendered by the at least a second user; and monitoring one or more tracks rendered by the at least a second user. The first user and the at least a second user may be the same user.

In another implementation, a computer program product resides on a computer readable medium that has a plurality of instructions stored on it. When executed by a processor, the instructions cause the processor to perform operations including monitoring a listening history of a first user. A listening history of at least a second user is monitored. At least a portion of the listening history of the first user is combined with at least a portion of the listening history of at least the second user to generate a hybrid listening history. One or more rules are applied to the hybrid listening history to generate a collaborative playlist. The rules are chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule.

One or more of the following features may be included. The first and/or at least the second user may be allowed to select one or more rules for applying to the hybrid listening history. The collaborative playlist may be maintained on a client electronic device and/or a server computer.

Monitoring a listening history of a first user may include one or more of: monitoring one or more playlists created by the first user; monitoring one or more playlists rendered by the first user; and monitoring one or more tracks rendered by the first user. Monitoring a listening history of at least a second user may include one or more of: monitoring one or more playlists created by the at least a second user; monitoring one or more playlists rendered by the at least a second user; and monitoring one or more tracks rendered by the at least a second user. The first user and the at least a second user may be the same user.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a collaborative playlist process;

FIG. 2 is a diagrammatic view of a screen rendered by the collaborative playlist process of FIG. 1;

FIG. 3 is a flowchart of the collaborative playlist process of FIG. 1;

FIG. 4 is a diagrammatic view of a screen rendered by the collaborative playlist process of FIG. 1;

FIG. 5 is a diagrammatic view of a screen rendered by the collaborative playlist process of FIG. 1; and

FIG. 6 is a diagrammatic view of a screen rendered by the collaborative playlist process of FIG. 1.

### DETAILED DESCRIPTION OF THE PREFERRED EMBODIMENTS

### System Overview:

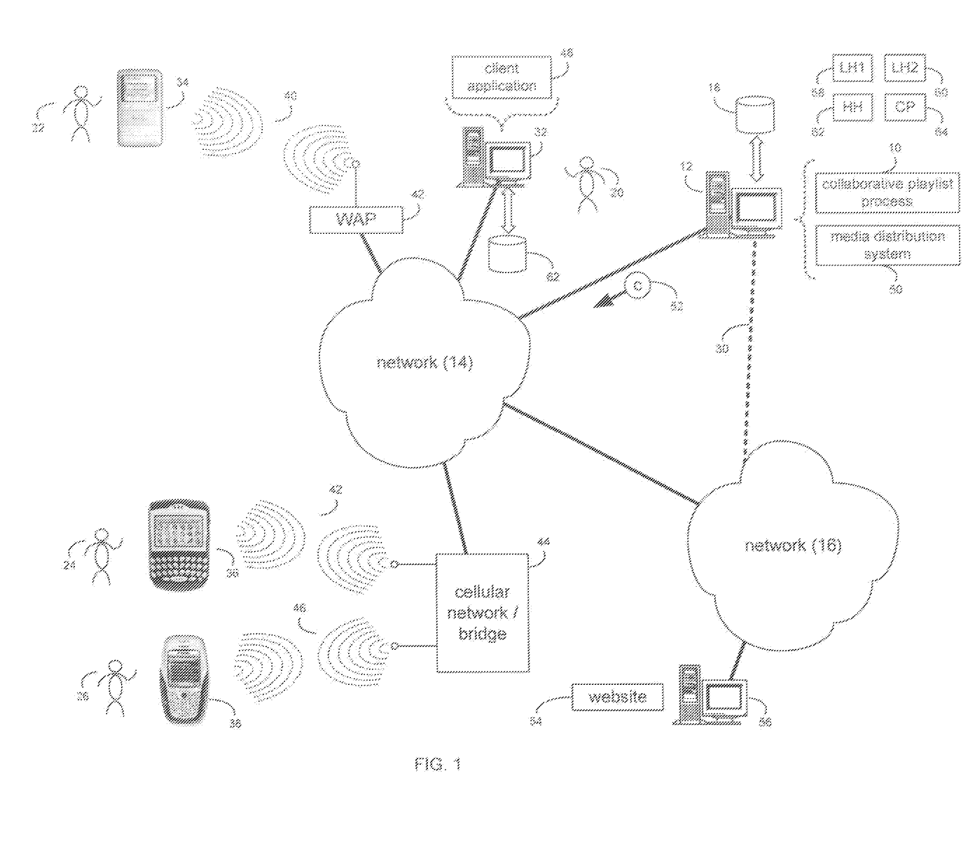

Referring to FIG. 1, there is shown a collaborative playlist process 10 that may reside on and may be executed by data server 12. As will be discussed below in greater detail, collaborative playlist process 10 may allow two or more users to generate a collaborative playlist by monitoring the listening history of each user to generate a hybrid listening history, which may be processed to generate the collaborative playlist.

Collaborative playlist process 10 may be a server application that may reside on and may be executed by data server 12, which may be connected to network 14 (e.g., the Internet). Data server 12 may be a web server (or series of servers) running a network operating system, examples of which may include but are not limited to: Microsoft Windows XP Server™; Novell Netware™; or Redhat Linux™, for example.

Data server 12 may also execute a web server application, examples of which may include but are not limited to: Microsoft IIS™, Novell Webserver™, or Apache Webserver™, that allows for HTTP (i.e., HyperText Transfer Protocol) access to data server 12 via network 14. Network 14 may be connected to one or more secondary networks (e.g., network 16), examples of which may include but are not limited to: a local area network; a wide area network; or an intranet, for example.

The instruction sets and subroutines of collaborative playlist process 10, which may be stored on a storage device 18 coupled to data server 12, may be executed by one or more processors (not shown) and one or more memory architectures (not shown) incorporated into data server 12. Storage device 18 may include but may not limited to: a hard disk drive; a tape drive; an optical drive; a RAID array; a random access memory (RAM); or a read-only memory (ROM).

Users 20, 22, 24, 26 may access collaborative playlist process 10 directly through network 14 or through secondary network 16. Further, data server 12 (i.e., the computer that executes collaborative playlist process 10) may be connected to network 14 through secondary network 16, as illustrated with phantom link line 30.

Users 20, 22, 24, 26 may access collaborative playlist process 10 through various client electronic devices, examples of which may include but are not limited to client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), a car audio system (not shown), a home audio device, such as those manufactured by Sonos, Inc of Santa Barbara Calif., and Roku Labs of Palo Alto, Calif. (not shown), and a portable gaming device (e.g., a Sony Playstation™ Portable, not shown), for example.

The various client devices may be directly or indirectly coupled to network 14 (or network 16). For example, client computer 32 is shown directly coupled to network 14 via a hardwired network connection. Further, personal media device 34 is shown wirelessly coupled to network 14 via wireless communication channel 40 established between personal media device 34 and wireless access point (i.e., WAP) 42, which is shown directly coupled to network 14. WAP 42 may be, for example, an IEEE 802.11a, 802.11b, 802.11g, Wi-Fi, and/or Bluetooth device that is capable of establishing wireless communication channel 40 between personal media device 34 and WAP 42.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Personal digital assistant 36 is shown wirelessly coupled to network 14 via wireless communication channel 42 established between personal digital assistant 36 and cellular network/bridge 44, which is shown directly coupled to network 14. Further, cellular telephone 38 is shown wirelessly coupled to network 14 via wireless communication channel 46 established between cellular telephone 38 and cellular network/bridge 44.

Client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), a car audio system (not shown), a home audio device, such as those manufactured by Sonos, Inc of Santa Barbara Calif., and Roku Labs of Palo Alto, Calif. (not shown), and a portable gaming device (e.g., a Sony Playstation™ Portable, not shown), may each execute a client application (e.g., client application 48) that may interface with media distribution system 50. Media distribution system 50 may provide media data streams and/or media data files (i.e., collectively referred to as tracks) to a plurality of users (e.g., users 20, 22, 24, 26). Examples of media distribution system 50 may include, but are not limited to, the Rhapsody™ service and Rhapsody-To-Go™ service offered by RealNetworks, Inc. of Seattle, Wash.

Client application 48 may be a web browser (e.g., Microsoft Internet Explorer™ and Netscape Navigator™, for example), a stand alone application, or an applet running within another program (e.g., Microsoft Internet Explorer™, Mozilla Firefox™, and Netscape Navigator™, for example). Client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), a car audio system (not shown), a home audio device, such as those manufactured by Sonos, Inc of Santa Barbara Calif., and Roku Labs of Palo Alto, Calif. (not shown), and a portable gaming device (e.g., a Sony Playstation™ Portable, not shown), may each execute an operating system, examples of which may include but are not limited to Microsoft Windows™, Microsoft Windows CE™, Redhat Linux™, or a custom operating system.

The instruction sets and subroutines of client application 48, which may be stored on a storage device (e.g., storage device 54) coupled to e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), a car audio system (not shown), a home audio device, such as those manufactured by Sonos, Inc of Santa Barbara Calif., and Roku Labs of Palo Alto, Calif. (not shown), or a portable gaming device (e.g., a Sony Playstation™ Portable, not shown), may be executed by one or more processors (not shown) and one or more memory architectures (not shown) incorporated into e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), a car audio system (not shown), a home audio device, such as those manufactured by Sonos, Inc of Santa Barbara Calif., and Roku Labs of Palo Alto, Calif. (not shown), or a portable gaming device (e.g., a Sony Playstation™ Portable, not shown). Storage device 54 may include but are not limited to a hard disk drive, a tape drive, an optical drive, a RAID array, a random access memory (RAM), a read-only memory (ROM), a compact flash (i.e., CF) memory, a secure digital (i.e., SD) memory, a trans flash memory, and/or a memory stick memory.

Media distribution system 50 may facilitates the transfer of digital content 16 from data server 12 to the various client devices (e.g., client computer 32, personal media device 34, personal digital assistant 36, cellular telephone 38, laptop computers (not shown), notebook computers (not shown), pagers (not shown), televisions (not shown), cable boxes (not shown), gaming devices (e.g., a Microsoft Xbox™, not shown), a car audio system (not shown), a home audio device, such as those manufactured by Sonos, Inc of Santa Barbara Calif., and Roku Labs of Palo Alto, Calif. (not shown), and portable gaming devices (e.g., a Sony Playstation™ Portable), for example).

The instruction sets and subroutines of media distribution system 50, which may be stored on a storage device 18 coupled to data server 12, may be executed by one or more processors (not shown) and one or more memory architectures (not shown) incorporated into data server 12. As discussed above, storage device 18 may include but are not limited to a hard disk drive, a tape drive, an optical drive, a RAID array, a random access memory (RAM), or a read-only memory (ROM).

Media content 52 may be, for example, digitally-encoded audio and/or video data that is compressed using known compression techniques. Examples of such compression techniques may include, but are not limited to, MPEG1, MPEG2, MPEG4, H.263, H.264, Advanced Audio Coding, and other techniques promulgated by the international standards organization (ISO) and/or the Motion Picture Experts Group (MPEG).

Examples of media content 52 received from media distribution system 50 may include, but are not limited to: purchased downloads received from media distribution system 50 (i.e., media content licensed to e.g., user 20 for use in perpetuity); subscription downloads received from media distribution system 50 (i.e., media content licensed to e.g., user 20 for use while a valid subscription exists with media distribution system 50); and media content streamed from media distribution system 50, for example. Typically, when media content 52 is streamed from e.g., data server 12 to client computer 32, a copy of media content 52 is not permanently retained on client computer 32.

Examples of the types of media content 52 distributed by media distribution system 50 include: audio files (examples of which may include but are not limited to music files, audio news broadcasts, audio sports broadcasts, and audio recordings of books, for example); video files (examples of which may include but are not limited to video footage that does not include sound, for example); audio/video files (examples of which may include but are not limited to a/v news broadcasts, a/v sports broadcasts, feature-length movies and movie clips, music videos, and episodes of television shows, for example); and multimedia content (examples of which may include but are not limited to interactive presentations and slideshows, for example).

Using client application 48, users 20, 22, 24, 26 may visit e.g., website 54 (which may be served by webserver 56), examples of which may include, but are not limited to: news websites (e.g., www.cnn.com, www.foxnews.com); weblog websites (e.g., www.blogspot.com, www.xanga.com); auction websites (e.g., www.ebay.com, www.bidz.com); dating/matchmaking websites (www.eharmony.com, www.match.com); special interest websites (e.g., www.ichef.com, www.imdb.com); search engine/internet portal websites (e.g., www.google.com, www.yahoo.com); ecommerce websites (e.g., www.amazon.com, www.overstock.com); and social networking websites (www.myspace.com, www.classmates.com, www.reunion.com, www.friendster.com, www.facebook.com).

### The Collaborative Playlist Process:

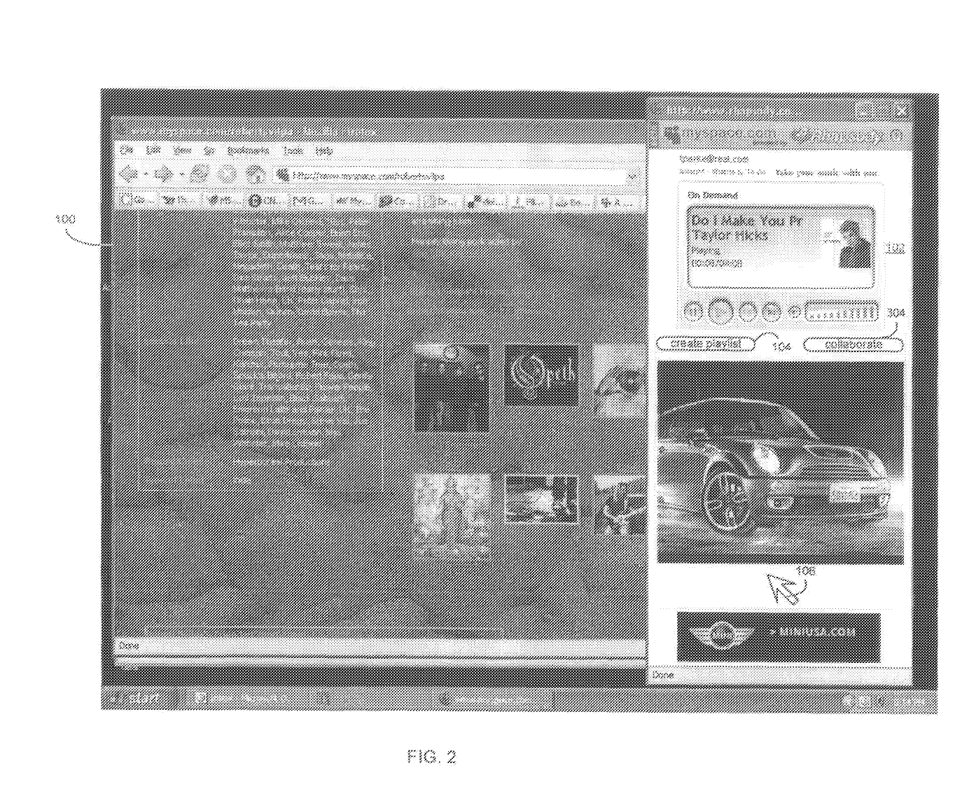

Referring also to FIG. 2, a user (e.g., user 20) may use a client application (e.g., client application 48) to browse website 54, an example of which may include but is not limited to a social networking website (e.g., www.myspace.com, www.classmates.com, www.reunion.com, www.friendster.com, and/or www.facebook.com). Client application 48 may render a webpage 100 of website 54, which is served by data server 12 and presented to user 20.

While browsing e.g., webpage 100, user 20 may launch an application (e.g., Rhapsody™ by RealNetworks, Inc. and Windows MediaPlayer™ by The Microsoft Corporation) 102 that e.g., renders tracks. For example, application 102 may render audio files, thus allowing user 20 to e.g., listen to music while browsing webpage 100. Additionally/alternatively, application 102 may render video files, thus allowing user 20 to e.g., watch video clips while browsing web page 100.

Application 102 may be a stand alone application (e.g., Rhapsody™ by RealNetworks, Inc. and Windows MediaPlayer™ by The Microsoft Corporation), or an applet running within another program (e.g., client application 48, for example).

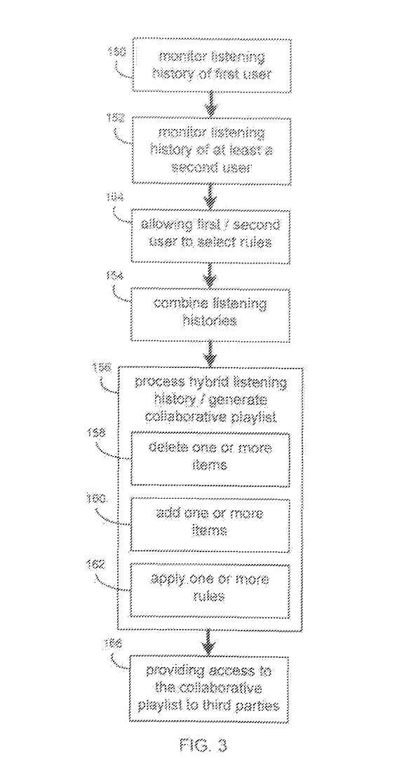

Referring also to FIG. 3, collaborative playlist process 10 may monitor 150 a listening history of a first user (e.g., user 20). Therefore, as user 20 renders tracks, collaborative playlist process 10 may generate listening history file 58 for user 20. Further, collaborative playlist process 10 may be configured to monitor 152 the listening histories of other users. Accordingly, collaborative playlist 10 may monitor 152 the listening history of user 22 and may generate listening history file 60 for user 22.

As will be discussed below in greater detail, collaborative playlist process 10 may combine 154 at least a portion the listening history (e.g., listening history file 58) of user 20 with at least a portion of the listening history (e.g., listening history file 60) of user 22 to generate hybrid listening history file 62, which may be processed 156 to generate collaborative playlist 64.

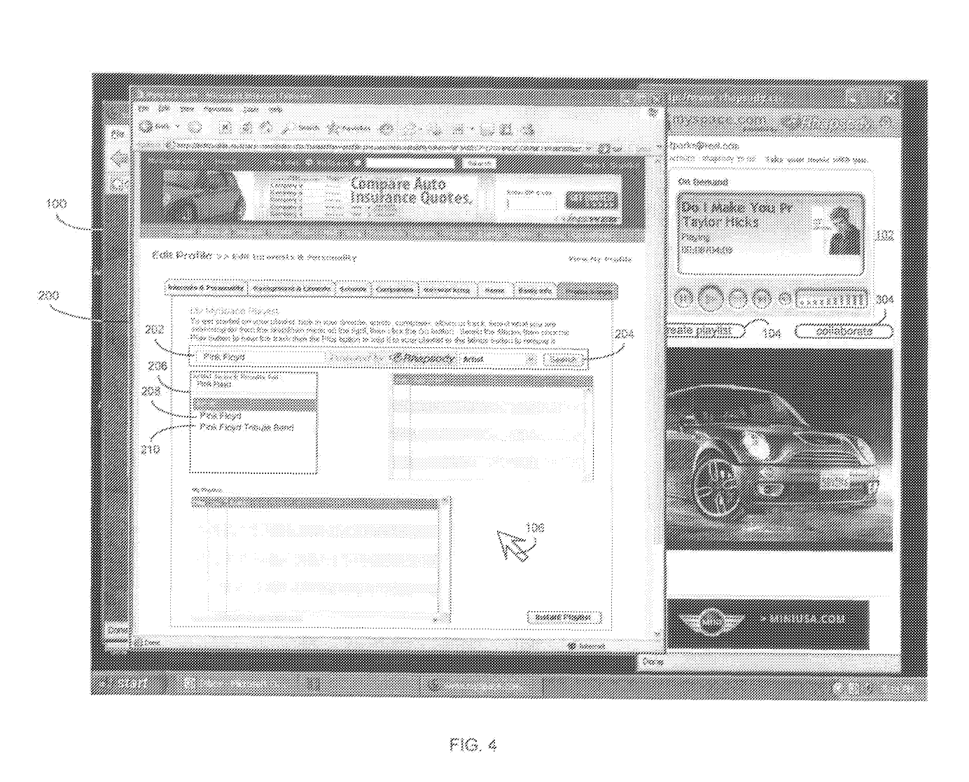

As discussed above, user 20 may use application 102 to render tracks. Application 102 may include a “create playlist” button 104 that may allow the user to define one or more tracks for rendering. Referring also to FIG. 4, user 20 may select “create playlist” button 104 using onscreen pointer 106, which may be controllable by a pointing device (e.g., a mouse, not shown). Upon selecting “create playlist” button 104, collaborative playlist process 10 may render selection window 200 that may allow user 20 to select (using screen point 106) tracks for rendering. For example, suppose that user 20 wished to listen to Pink Floyd. User 20 may enter “Pink Floyd” into query field 202 and select “search” button 204 (using screen point 106). Upon selecting “search” button 204, results field 206 may be populated with one or more potential matches. In this example, result field 206 is shown to include to potential matches, namely “Pink Floyd” 208 and “Pink Floyd Tribute Band” 210. Assuming that user 20 wishes to listen to “Pink Floyd” 208, user 20 may select “Pink Floyd” 208 (using screen pointer 106) from result field 206.

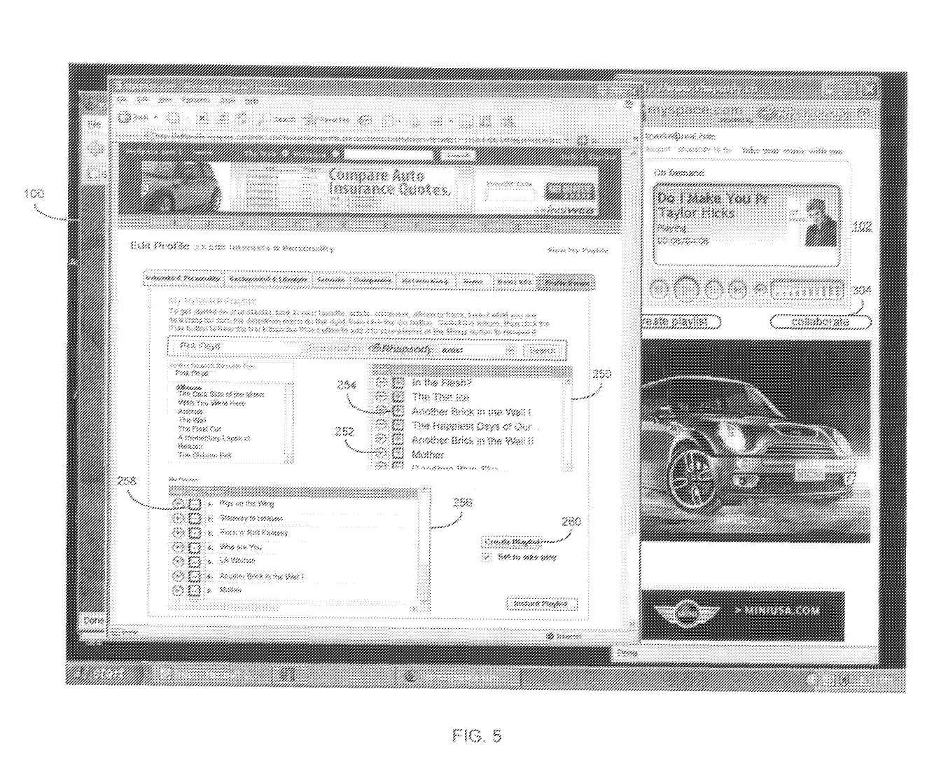

Referring also to FIG. 5, selecting “Pink Floyd” 208 may result in the population of track window 250 with one or more track descriptors (e.g., “In The Flesh?”, “The Thin Ice”, Another Brick in the Wall I”, etc.) for one or more tracks performed by the selected artist (e.g. Pink Floyd). User 20 may select one or more of these tracks for rendering by selecting (using screen pointer 106) e.g., the “Play” button 252 associated with the desired track. Additionally/alternatively, user 20 may add a track to a playlist by selecting (using screen pointer 106) the “Add” button 254 associated with the desired track. Playlist window 256 may define a playlist for user 20. For example, by selecting “Add” button 254, track “Another Brick in the Wall I” may be added to the playlist defined within playlist window 256. In the event that user 20 wishes to remove a song from the playlist defined within playlist window 256, user 20 may select the “Delete” button 258 associated with the track to be removed from the playlist defined within playlist window 256.

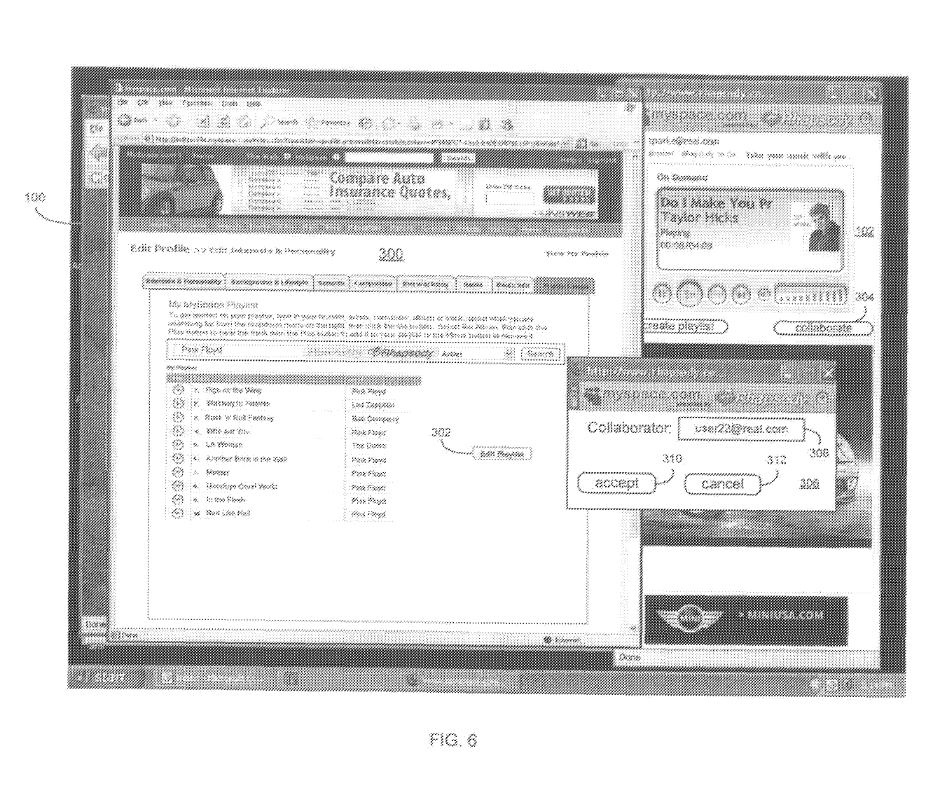

User 20 may select (using screen pointer 106) “Create Playlist” button 260, which may result in collaborative playlist process 10 rendering a playlist naming window (not shown) that allows user 20 to save a playlist under e.g., a user-defined name. Referring also to FIG. 6, upon saving a playlist, collaborative playlist process 10 may render playlist detail window 300 that itemizes the individual tracks included within the playlist. In this example, the playlist defined within playlist detail window 300 defines ten tracks, namely: “Pigs on the Wing”; “Stairway to Heaven”; “Rock ‘n’ Roll Fantasy”; “Who are You”; “LA Woman”; “Another Brick in the Wall I”; “Mother”; “Goodbye Cruel World”; “In the Flesh”; and “Run like Hell”. Playlist detail window 300 may define the artist associated with each track defined within the playlist. Additionally, collaborative playlist process 10 may allow user 20 to edit the playlist by e.g., selecting (using screen pointer 106) “Edit Playlist”, which may allow user 20 to e.g., add and/or remove tracks from the playlist.

As discussed above, collaborative playlist process 10 may monitor 150 a listening history of a first user (e.g., user 20) and save that listening history as e.g., history file 58. Further, collaborative playlist process 10 may monitor 152 the listening histories of other users (e.g., user 22) and save that listening history as e.g., history file 60. History files 58, 60 may represent all or a portion of a playlist defined by a user. Alternatively, history files 58, 60 may represent tracks rendered by the user. Accordingly, for user 20, history file 58 may define ten tracks, namely: “Pigs on the Wing”; “Stairway to Heaven”; “Rock ‘n’ Roll Fantasy”; “Who are You”; “LA Woman”; “Another Brick in the Wall I”; “Mother”; “Goodbye Cruel World”; “In the Flesh”; and “Run like Hell” (i.e., the tracks itemized within playlist detail window 300). However, history file 58 may be configured to only define rendered tracks. Assuming (for this example) that user 20 only rendered the first four tracks defined within the playlist, history file 58 may only define four tracks, namely: “Pigs on the Wing”; “Stairway to Heaven”; “Rock ‘n’ Roll Fantasy”; and “Who are You”.

As discussed above, collaborative process 10 may allow two or more users to generate a collaborative playlist by monitoring 150, 152 the listening history of each user to generate a hybrid listening history, which may be processed 156 to generate the collaborative playlist.

To initiate this collaborative process, user 20 and/or user 22 may select (using screen pointer 106) “Collaborate” button 304. Once selected, collaborative playlist process 10 may render a collaborator selection window 306 that may allow the user to define other users with whom they wish to collaborate. Collaborator playlist window 306 may include one or more populatable fields 308 in which the user (e.g., user 20) may identify the person with which they wish to collaborate. This identification may be made may entering an identifier that allows collaborative playlist process 10 to unambiguously identify the collaborator. For example, assume that user 20 wished to collaborate with user 22 and that collaborative playlist process 10 identified users in accordance with their email address. User 20 may enter the email address of user 22 (e.g., user22@real.com) into field 308 and may select (using screen pointer 106) “accept” button 310 to begin the collaboration process. Alternatively, user 20 may cancel the collaboration process by selecting (using screen pointer 106) “Cancel” button 312. Once the collaboration process is initiated, the selected collaborator (e.g., user 22) may be notified to verify that e.g., user 22 wishes to collaborate with user 20.

Alternatively, the collaboration process may be more automated. For example, collaborative playlist process 10 may automatically create a collaborative playlist for e.g., all Seattle area users that are currently online. Further, users may not be required to “accept” their inclusion in the collaboration process. For example, users may be automatically selected for inclusion within a particular group, for which a collaborative playlist may be generated.

Once the collaboration process is initiated, collaborative playlist process 10 may combine 154 at least a portion of the listening history (e.g., history file 58) of the first user (e.g., user 20) with at least a portion of the listening history (e.g., history file 60) of at least the second user (user 22) to generate a hybrid listening history (e.g., hybrid listening history file 62). While two “collaborators” (i.e., users 20, 22) are discussed in this example, this is for illustrative purposes only and is not intended to be a limitation of this disclosure. For example, the maximum number of collaborators may be defined to be as many as the administrator (not shown) of collaborative playlist process 10 deems appropriate. For very large groups of listeners (e.g., one million Pink Floyd listeners that are currently online), collaborative playlist process 10 may systematically randomize the collaborators to obtain a sub-sample collaborative playlist across various demographics to represent various collaborative playlists from the group.

Continuing with the above-stated example, assume that collaborative playlist process 10 is configured to include within a history file only those tracks that were actually rendered by the user. Accordingly, history file 58 (i.e., which defines the listening history of user 20) may define four tracks, namely: “Pigs on the Wing”; “Stairway to Heaven”; “Rock ‘n’ Roll Fantasy”; and “Who are You”. Further, assume that user 22 (i.e., a Bruce Springsteen fan) has listened to six Bruce Springsteen tracks. Accordingly history file 60 (i.e., which defines the listening history of user 22) may define those six tracks, namely “Backstreets”; Rosalita (Come Out Tonight); “Born to Run”; “Darkness on the Edge of Town”; “Dancing in the Dark”; and “Glory Days”.

Collaborative playlist process 10 may combine 154 at least a portion of history file 58 with at least a portion of history file 60 to generate a hybrid listening history file 62. Therefore, if collaborative playlist process 10 is configured to use all of each history file 58, 60, hybrid listening history file 62 may include “Pigs on the Wing”; “Stairway to Heaven”; “Rock ‘n’ Roll Fantasy”; “Who are You”; “Backstreets”; Rosalita (Come Out Tonight); “Born to Run”; “Darkness on the Edge of Town”; “Dancing in the Dark”; and “Glory Days”. Alternatively, collaborative playlist process 10 may be configured to only use a portion of each history file. For example, if collaborative playlist process 10 is configured to only use tracks rendered within the last seven days, the number of files included within hybrid listening history file 62 may be reduced to e.g., four tracks (“Rock ‘n’ Roll Fantasy”; “Who are You”; “Dancing in the Dark”; and “Glory Days”).

Collaborative playlist process 10 may process 156 hybrid listening history file 62 to generate collaborative playlist 64. Processing 156 hybrid listening history file 64 may include deleting 158 one or more items from the hybrid listening history. For example, one or more rules may govern the rendering of tracks. An example of such a rule set is the Digital Millennium Copyright Act.

The Digital Millennium Copyright Act of 1998 may limit the number of times that a particular song, artist, or group of artists may be rendered within a specified time interval. When rendering a sequence of tracks (such as the sequence defined within collaborative playlist 64), the sequence may only comply with the Digital Millennium Copyright Act if e.g., over a three-hour time interval: (i) no more than three tracks from the same album are rendered; (ii) no more than two consecutive tracks from the same album are rendered; (iii) no more than four tracks from the same artist (i.e., individual/group) or anthology are rendered; and (iv) no more than three consecutive tracks from the same artist (i.e., individual/group) or anthology are rendered. Accordingly, if all of the tracks defined within collaborative playlist 64 are from a single artist, this sequence may violate the Digital Millennium Copyright Act. If such a situation occurs, collaborative playlist process 10 may delete 158 one or more tracks from collaborative playlist 64 until collaborative playlist 64 is in compliance with the Digital Millennium Copyright Act. However, DMCA compliance may not always be applicable/desirable. For example, DMCA compliance may be less of a concern for subscription-based users and more of a concern for free users.

When processing hybrid listening history 64, collaborative playlist process 10 may add 160 one or more tracks to hybrid listening history file 64. For example, if hybrid listening history file 64 defines a limited number of tracks, collaborative playlist process 10 may supplement hybrid listening history file 64 by adding 160 tracks to hybrid listening history file 64. However, when defining additional tracks for inclusion within hybrid listening history 64, collaborative playlist process 10 may determine compliance with e.g., The Digital Millennium Copyright Act.

When processing 156 hybrid listening history file 64, collaborative playlist process 10 may apply 162 one or more rules to hybrid listening history file 64 that may e.g., govern which tracks may be added 160 to and/or deleted 158 from hybrid listening history 64. Examples of the rules that may be applied may include but are not limited to:

### Genre and Subgenre Rules:

Tracks may be added 160 to and/or deleted 158 from hybrid listening history file 62 to focus collaborative playlist 64 based upon one or more genres/subgenres.

Examples of such music genres and subgenres may include but are not limited to: Jazz>Acid Jazz; Electronica/Dance>Downtempo>Acid Jazz; Electronica/Dance>Beats & Breaks>Broken Beat.

Hybrid listening history file 62 may be focused by genre(s), such as an entire tree of a genre (e.g., “Electronica”) or a specific sub-genre of the tree (e.g., “Electronica/Dance>Downtempo>Trip-Hop”), for example.

### Artist Relationship Rules:

Tracks may be added 160 to and/or deleted 158 from hybrid listening history file 62 to focus collaborative playlist 64 based upon various artist relationships.

For example, hybrid listening history file 62 may be modified to focus collaborative playlist 64 on e.g.: artists who were influenced by Duke Ellington; artists that had similar friends/influences; artists that were panned by a particular reviewer; artists that played certain venues within three months of each other; and/or artists that have collaborated with a certain artist on at least one track/album, for example.

### Geography Rules:

Tracks may be added 160 to and/or deleted 158 from hybrid listening history file 62 to focus collaborative playlist 64 based on a specific geographic relationship.

For example, hybrid listening history file 62 may be modified to focus collaborative playlist 64 on e.g.: artists that were born in Germany; artists that played a concert in Germany; recordings that were made in Germany; and/or artists married to a person of German descent, for example.

### Playback Timeframe Rules:

Tracks may be added 160 to and/or deleted 158 from hybrid listening history file 62 to focus collaborative playlist 64 based on current listen trends of the collaborators.

For example, hybrid listening history file 62 may be modified to focus collaborative playlist 64 on e.g.: what the collaborators have listened to during the past hour; what the collaborators have listened to during the past day; what the collaborators have listened to during the past week; what the collaborators have listened to during the past month; what the collaborators have listened to during the past year; what the collaborators have listened to at any time; and/or what the collaborators have not listened to in a specific period of time, for example.

### Recording Time Rules:

Tracks may be added 160 to and/or deleted 158 from hybrid listening history file 62 to focus collaborative playlist 64 based on time-based rules.

For example, hybrid listening history file 62 may be modified to focus collaborative playlist 64 on e.g.: on all music that was recorded between 1983 and 1985; all music that was recorded by musicians who were at least 70 years old at the time of the recording; and/or all music that was recorded by musicians who were born after 1989, for example.

### Label Rules:

Tracks may be added 160 to and/or deleted 158 from hybrid listening history file 62 to focus collaborative playlist 64 based on label-based rules.

For example, hybrid listening history file 62 may be modified to focus collaborative playlist 64 on e.g.: artists who have at least ten albums recorded with the label, EMI; and/or artists who have recorded on Philips, Deutsche Grammophon and Angel, for example.

### Artist Name Rules:

Tracks may be added 160 to and/or deleted 158 from hybrid listening history file 62 to focus collaborative playlist 64 based on artist name-based rules.

For example, hybrid listening history file 62 may be modified to focus collaborative playlist 64 on e.g.: artists whose last name begins with “R”; and or artists whose first name is “James” or “Bob” or “Frank”, for example.

### Artist Status Rules:

Tracks may be added 160 to and/or deleted 158 from hybrid listening history file 62 to focus collaborative playlist 64 based on artist status-based rules.

For example, hybrid listening history file 62 may be modified to focus collaborative playlist 64 on e.g.: artists who have won a Grammy; artists who have been arrested; and/or artists who have died within the last year and had a N.Y. Times obituary, for example.

### Artist Discography Rules:

Tracks may be added 160 to and/or deleted 158 from hybrid listening history file 62 to focus collaborative playlist 64 based on discography-based rules.

For example, hybrid listening history file 62 may be modified to focus collaborative playlist 64 on e.g.: artists who recorded at least three albums; and/or artists who recorded a track with the word “rainbow”, for example.

### Ratings Rules:

Tracks may be added 160 to and/or deleted 158 from hybrid listening history file 62 to focus collaborative playlist 64 based on ratings.

For example, hybrid listening history file 62 may be modified to focus collaborative playlist 64 on e.g.: only tracks that have been rated at least four stars by either/both/at least “X” number of collaborators; and/or only tracks from artists that a particular collaborator has rated at least three stars, for example.

### Listening Properties Rules:

Tracks may be added 160 to and/or deleted 158 from hybrid listening history file 62 to focus collaborative playlist 64 based on listening properties.

For example, hybrid listening history file 62 may be modified to focus collaborative playlist 64 on e.g.,: only tracks from artists for whom the original user has played at least three consecutive tracks; and/or only tracks in which the original user played more than 70% of the length of the track before skipping ahead.

One or more of the above-described rules may be automatically applied by collaborative playlist process 10. Additionally/alternatively, collaborative playlist process 10 may allow 164 one or more of the collaborators to select one or more of the above-described rules for application. For example, when electing to collaborate (by e.g., selecting collaborate button 304), user 20 may be presented with an option screen (not shown) that allows user 20 to select which rules to apply to hybrid listening history file 62 (and, therefore, collaborative playlist 64).

Once generated, collaborative playlist 64 may be maintained on a server computer (data server 12) and/or a client electronic device (e.g., client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), a car audio system (not shown), a home audio device, such as those manufactured by Sonos, Inc of Santa Barbara Calif., and Roku Labs of Palo Alto, Calif. (not shown), and a portable gaming device (e.g., a Sony Playstation™ Portable, not shown), for example).

Third parties may be provided 166 access to collaborative playlist 64. For example, collaborative playlist process 10 may allow user 20 and/or user 22 to post collaborative playlist 64 to one or more social networking websites (www.myspace.com, www.classmates.com, www.reunion.com, www.friendster.com, www.facebook.com), thus providing access to e.g., user 24 (i.e., a third party).

While several rules are defined above, this is for illustrative purposes only and is not intended to be a limitation of this disclosure. For example, rules may be applied that add/remove tracks from hybrid listening history file 62 based on e.g., the favorite foods of the artist, or the socioeconomic background of the artist, for example. Accordingly, the rules applied by collaborative playlist process 10 may only be limited by the information known about each track available via e.g., media distribution system 50.

While collaborative playlist process 10 is described above as being resident on and executed by data server 10, this is for illustrative purposes only and is not intended to be a limitation of this disclosure. For example, collaborative playlist process may be resident on and executed by a client electronic device, examples of which may include but are not limited to client computer 32, personal media device 34, personal digital assistant 36, cellular telephone 38, a laptop computer (not shown), a notebook computer (not shown), a pager (not shown), a television (not shown), a cable box (not shown), a gaming device (e.g., a Microsoft Xbox™, not shown), a car audio system (not shown), a home audio device, such as those manufactured by Sonos, Inc of Santa Barbara Calif., and Roku Labs of Palo Alto, Calif. (not shown), and a portable gaming device (e.g., a Sony Playstation™ Portable, not shown). Additionally/alternatively, collaborative playlist process 10 may be partially executed on data server 12 and partially executed on a client electronic device.

While collaborative playlist process 10 is described above as monitoring a first user and at least a second user, the first user and the at least a second user may actually be the same user during two different chronological periods. Accordingly, a single user may collaborate to create a collaborative playlist. For example, if user 20 recently created a first playlist and had created a second playlist one year earlier, collaborative playlist process 10 may use these two playlists (both of which were created by user 20) to create collaborative playlist 64.

A number of implementations have been described. Nevertheless, it will be understood that various modifications may be made. Accordingly, other implementations are within the scope of the following claims.

What is claimed is:

1. A method comprising:
monitoring a listening history of a first user;
monitoring a listening history of at least a second user;
combining at least a portion of the listening history of the first user with at least a portion of the listening history of at least the second user to generate a hybrid listening history; and
processing the hybrid listening history to generate a collaborative playlist.

2. The method of claim 1 further comprising:
providing access to the collaborative playlist to third parties.

3. The method of claim 1 wherein processing the hybrid listening history includes:
deleting one or more items from the hybrid listening history.

4. The method of claim 1 wherein processing the hybrid listening history includes:
adding one or more items to the hybrid listening history.

5. The method of claim 1 wherein processing the hybrid listening history includes:
applying one or more rules to the hybrid listening history.

6. The method of claim 5 wherein the rules are chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule.

7. The method of claim 5 further comprising:
allowing the first and/or at least a second user to select one or more rules for applying to the hybrid listening history.

8. The method of claim 1 wherein the collaborative playlist is maintained on a client electronic device.

9. The method of claim 1 wherein the collaborative playlist is maintained on a server computer.

10. The method of claim 1 wherein monitoring a listening history of a first user includes one or more of:
monitoring one or more playlists created by the first user;
monitoring one or more playlists rendered by the first user; and
monitoring one or more tracks rendered by the first user.

11. The method of claim 1 wherein monitoring a listening history of at least a second user includes one or more of:
monitoring one or more playlists created by the at least a second user;
monitoring one or more playlists rendered by the at least a second user; and
monitoring one or more tracks rendered by the at least a second user.

12. The method of claim 1 wherein the first user and the at least a second user are the same user.

13. A computer program product residing on a computer readable medium having a plurality of instructions stored thereon which, when executed by a processor, cause the processor to perform operations comprising:
monitoring a listening history of a first user;
monitoring a listening history of at least a second user;
combining at least a portion of the listening history of the first user with at least a portion of the listening history of at least the second user to generate a hybrid listening history; and
processing the hybrid listening history to generate a collaborative playlist.

14. The computer program product of claim 13 further comprising instructions for:
providing access to the collaborative playlist to third parties.

15. The computer program product of claim 13 wherein the instructions for processing the hybrid listening history include instructions for:
deleting one or more items from the hybrid listening history.

16. The computer program product of claim 13 wherein the instructions for processing the hybrid listening history include instructions for:
adding one or more items to the hybrid listening history.

17. The computer program product of claim 13 wherein the instructions for processing the hybrid listening history include instructions for:
applying one or more rules to the hybrid listening history.

18. The computer program product of claim 17 wherein the rules are chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule.

19. The computer program product of claim 17 further comprising instructions for:
allowing the first and/or at least a second user to select one or more rules for applying to the hybrid listening history.

20. The computer program product of claim 13 wherein the collaborative playlist is maintained on a client electronic device.

21. The computer program product of claim 13 wherein the collaborative playlist is maintained on a server computer.

22. The computer program product of claim 13 wherein the instructions for monitoring a listening history of a first user include instructions for one or more of:
monitoring one or more playlists created by the first user;
monitoring one or more playlists rendered by the first user; and
monitoring one or more tracks rendered by the first user.

23. The computer program product of claim 13 wherein the instructions for monitoring a listening history of at least a second user include instructions for one or more of:
monitoring one or more playlists created by the at least a second user;
monitoring one or more playlists rendered by the at least a second user; and
monitoring one or more tracks rendered by the at least a second user.

24. The computer program product of claim 13 wherein the first user and the at least a second user are the same user.

25. A method comprising:
monitoring a listening history of a first user;
monitoring a listening history of at least a second user;
combining at least a portion of the listening history of the first user with at least a portion of the listening history of at least the second user to generate a hybrid listening history; and
applying one or more rules to the hybrid listening history to generate a collaborative playlist, wherein the rules are chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule.

26. The method of claim 25 further comprising:
allowing the first and/or at least a second user to select one or more rules for applying to the hybrid listening history.

27. The method of claim 25 wherein the collaborative playlist is maintained on a client electronic device.

28. The method of claim 25 wherein the collaborative playlist is maintained on a server computer.

29. The method of claim 25 wherein monitoring a listening history of a first user includes one or more of:
monitoring one or more playlists created by the first user;
monitoring one or more playlists rendered by the first user; and
monitoring one or more tracks rendered by the first user.

30. The method of claim 25 wherein monitoring a listening history of at least a second user includes one or more of:
monitoring one or more playlists created by the at least a second user;
monitoring one or more playlists rendered by the at least a second user; and
monitoring one or more tracks rendered by the at least a second user.

31. The method of claim 25 wherein the first user and the at least a second user are the same user.

32. A computer program product residing on a computer readable medium having a plurality of instructions stored thereon which, when executed by a processor, cause the processor to perform operations comprising:
monitoring a listening history of a first user;
monitoring a listening history of at least a second user;
combining at least a portion of the listening history of the first user with at least a portion of the listening history of at least the second user to generate a hybrid listening history; and
applying one or more rules to the hybrid listening history to generate a collaborative playlist, wherein the rules are chosen from the group consisting of: a genre rule, an artist relationship rule; a geography rule; a playback timeframe rule; a recording time rule; a label rule; an artist name rule; an artist status rule; a artist discography rule; a rating rule; and a listening properties rule.

33. The computer program product of claim 32 further comprising instructions for:
allowing the first and/or at least a second user to select one or more rules for applying to the hybrid listening history.

34. The computer program product of claim 32 wherein the collaborative playlist is maintained on a client electronic device.

35. The computer program product of claim 32 wherein the collaborative playlist is maintained on a server computer.

36. The computer program product of claim 32 wherein the instructions for monitoring a listening history of a first user include instructions for one or more of:
monitoring one or more playlists created by the first user;
monitoring one or more playlists rendered by the first user; and
monitoring one or more tracks rendered by the first user.

37. The computer program product of claim 32 wherein the instructions for monitoring a listening history of at least a second user include instructions for one or more of:
monitoring one or more playlists created by the at least a second user;
monitoring one or more playlists rendered by the at least a second user; and
monitoring one or more tracks rendered by the at least a second user.

38. The computer program product of claim 32 wherein the first user and the at least a second user are the same user.
